(19) United States
(12) Patent Application Publication
(10) Pub. No.: US 2005/0156702 A1
(43) Pub. Date: Jul. 21, 2005

(54) Motionless electromagnetic turbine

(76) Inventor: Eric Giles Marshall, Harrison Hot Springs (CA)

Correspondence Address: ERIC GILES MARSHALL, 217, 378 ESPLANADE AVENUE, HARRISON HOT SPRINGS, BC, V0M 1K0, CA

(21) Appl. No.: 10/759,829

(22) Filed: Jan. 20, 2004

(51) Int. Cl. H01F 27/24

(52) U.S. Cl. 336/214

(57) ABSTRACT

An electromagnetic turbine without moving parts includes a magnetic core with three magnetic paths and magnetic connectors arranged between the three paths forming two adjacent closed magnetic loops. Three coils extend individually around portions of each magnetic path. The three coils are electrically pulsed to provide current pulses in the coils. Driving electrical current through each of the coils in sequence results in a flow of magnetic flux external to the magnetic core. The sequence is arranged to create a continuous one-way flow of magnetic flux through the inside of the core, then out one end where the flux extends outward and sweeps external to the core to the opposite end of the core where the flux collapses into the core. The sweeping magnetic flux induces electrical currents into electrically conductive material external to and not part of the turbine. Magnetic flux from the external currents interacts with the sweeping flux, resulting in a net force. The force either absorbs energy from relative deceleration of external material, converting the deceleration to electrical energy; or electrical energy provides relative acceleration of external material, converting the electrical energy to acceleration.

### BACKGROUND INFORMATION

1. Field of Invention

This invention relates to an electromagnetic turbine used to convert electrical power to relative motion without moving parts, and, more particularly, to such a device having a capability, when operating, of converting electrical power to relative movement in material external to, and not part of the turbine. In similar fashion, the same electromagnetic turbine without moving parts can also be used to convert relative movement from material external to and not part of the turbine, to electrical power.

2. Description of the Related Art

The patent literature describes a number of magnetic motors and generators, including permanent magnets and/or electromagnets, magnetic paths and magnetic conductors forming magnetic loops. Each magnetic loop extends between the opposite poles of permanent magnets and/or electromagnets, with electrical switching means for causing magnetic flux to flow in sequence along the magnetic paths. The magnetic paths are surrounded by one or more coils in which electrical current is induced to flow either by application of external electrical inputs or by changes in the magnetic flux within the device. These devices operate in accordance with Faraday's Law, indicating that an electrical current induces a magnetic field that surrounds a conductor and that an electrical current is induced into a conductor within a changing magnetic field.

On Mar. 26, 2002, U.S. Pat. No. 6,362,718 was granted to Patrick, et al, which is incorporated herein by reference. The patent describes a motionless electromagnetic generator, comprising an electromagnetic generator without moving parts consisting of a magnetic core including first and second magnetic paths and a permanent magnet in the center forming two adjacent closed magnetic loops. A first input coil and a first output coil extend around portions of the first magnetic path, while a second input coil and a second output coil extend around portions of the second magnetic path. The input coils are alternatively pulsed to provide induced current pulses in the output coils. Driving electrical current through each of the input coils reduces a level of flux from the permanent magnet within the magnet path around which the input coil extends, forcing the flux to sweep external to the core, toggling back and forth between the alternate paths. The patent contends that by tuning the frequency and intensity of the toggling action, the sweeping flux absorbs energy from the external environment, resulting in a net generation of electricity. How the toggling action of the sweeping flux absorbs external energy and converts it to electricity is unclear since there apparently is no relative net motion change and therefore no net acceleration or deceleration of material external to the generator. The permanent magnet in the center magnetic path, permanently holds the state of magnetic flux in the center path, preventing flux flow through the inside of the core. By comparison, my invention does not contain a permanent magnet in the center path, but rather contains a coil allowing bipolar control of flux in the center path, and therefore bi-directional control of flux flow inside the core. This difference is significant and differentiates my invention by allowing continuous and controllable flux flow in the device, key to efficient operation as a motor or a generator. Furthermore, the addition of a coil around the center path obviates the need for so-called input or control coils surrounding portions of the first and second path.

The patent of Patrick, et al, also contains numerous references to prior art, all supporting the basic fundamentals by which the device operates, but none conflicting within the scope and claims of the device. In similar fashion those same references support the basic fundamentals by which the present invention operates, but none conflicting within the scope and claims of the present invention. Those numerous references to prior art, by association are hereby incorporated herein.

On Jun. 15, 1993 I filed an application for patent with the USPTO titled:
‘AN ELECTROMOTIVE APPARATUS HAVING A FIRST COMPONENT MOVABLE IN RELATION TO A SECOND COMPONENT’
   Ser. No. 08/076,844 was assigned. This application was eventually abandoned.

On Jul. 9, 1997 I re-filed the application with the USPTO, with new information and a new title:
‘LATERAL POLE SPACING vs MAGNETIC SHORT CIRCUITS IN ELECTROMOTIVE DEVICES’
   Ser. No. 08/890,407 was assigned. This application was also eventually abandoned.

On Dec. 9, 2002 I filed a different but related application for patent with the USPTO titled:
‘HIGH TORQUE BRUSHLESS DC MOTORS AND GENERATORS’
   Ser. No. 10/313,889 was assigned. This application is still pending and most recent correspondence confirmation number 8233 was received.

These references to my former related patent applications are included to illustrate my immense commitment to and thorough understanding of related subject matter. These former applications refer individually and inclusively to three phase electromechanical motors, generators, and three phase electronic inverters capable of generating and regenerating three phase sine waves or quasi-sine waves. The pending application Ser. No. 10/313,889 illustrates geometric relationships eliminating magnetic short circuits and providing sine wave output waveforms with axially extended rotors and stators in three phase electromechanical motors and generators. The pending application also illustrates three phase bidirectional buck-boost pulse width modulation control circuits, permanent magnet concentration applied to three phase permanent magnet motors and generators, back-EMF rotor position sensing, and Hall Effect magnetic sensing to enhance electronic switching precision in three phase motors. Finally, the pending application also illustrates a speed independent rotating transformer inductive coupling mechanism for regulating rotor field excitation power, that performs a similar function to brushes and slip rings in a three phase electromechanical motor or generator, but without mechanical contact. I hereby state and confirm that I independently conceived, fabricated, and tested the electromechanical mechanisms, electronic circuits, and electrical apparatus in the prior and pending inventions. It will be obvious to one skilled in the art that the present invention represents a culmination of the inventive process. It will also be obvious that the three phase electromechanical generators and motors, three phase electronic inverters, and other electrical apparatus represented in my prior and pending patent applications; will work with, provide appropriate electrical power to, or accept electrical power from, the apparatus of the present invention.

### SUMMARY OF THE INVENTION

It is a first objective of the present invention to provide a magnetic turbine that exerts a net force resulting in relative movement in material external to and not part of the turbine, converting electrical energy to relative motion.

It is a second objective of the present invention to provide a magnetic turbine that exerts a net force resulting from relative movement in material external to and not part of the turbine, converting relative motion to electrical energy.

It is a third objective of the present invention to provide a magnetic turbine in which a net force exerted in material external to and not part of the turbine is accomplished without moving parts.

In the apparatus of the present invention, the path of the magnetic fields in the magnetic core is switched in a manner resulting in a flow of magnetic flux within the magnetic core. The sequence is arranged to create a continuous one-way flow of magnetic flux through the inside of the core, then out one end where the flux extends outward and sweeps external to the core to the opposite end where the flux collapses into the core. The sweeping magnetic flux induces electrical currents into electrically conductive material external to and not part of the turbine. Magnetic flux from the external currents interacts with the sweeping flux, resulting in a net force.

According to the first objective of the present invention, an electromagnetic motor is provided, including a magnetic core with three magnetic paths and magnetic connectors arranged between the three paths forming two adjacent closed magnetic loops. Three coils extend individually around portions of each magnetic path. The three coils are electrically pulsed to provide current pulses in the coils. Driving electrical current through each of the coils in sequence results in a flow of magnetic flux external to the magnetic core. Timing of the pulses results in external magnetic flux sweeping faster than the relative movement of the electrically conductive material external to the turbine. The sweeping magnetic flux induces electrical currents into electrically conductive material external to the turbine inducing a magnetic flux that opposes the motion of the sweeping flux, resulting in a net propulsive acceleration.

According to a second objective of the present invention, an electromagnetic generator is provided, including a magnetic core with three magnetic paths and magnetic connectors arranged between the three paths forming two adjacent closed magnetic loops. Three coils extend individually around portions of each magnetic path. The three coils are electrically pulsed to provide current pulses in the coils. Driving electrical current through each of the coils in sequence results in a flow of magnetic flux external to the magnetic core. The sweeping magnetic flux induces electrical currents into electrically conductive material external to the turbine inducing a magnetic flux that reinforces the motion of the sweeping flux. Timing of the pulses results in the external sweeping flux decelerating the relative movement of the electrically conductive material external to the turbine, resulting in an acceleration of flux flow in the core and a net generation of electrical energy in the coils.

According to a third objective of the present invention, an electromagnetic turbine without moving parts is provided, including a magnetic core with three magnetic paths and magnetic connectors arranged between the three paths forming two adjacent closed magnetic loops. Three coils extend individually around portions of each magnetic path. The three coils are electrically pulsed to provide current pulses in the coils. Driving electrical current through each of the coils in sequence results in a flow of magnetic flux external to the magnetic core. The sweeping magnetic flux induces electrical currents into electrically conductive material external to the core. Magnetic flux from the external currents interacts with the sweeping flux, resulting in a net accelerating or decelerating force, without moving parts.

### BRIEF DESCRIPTION OF THE DRAWINGS

FIG. 1 is a partly schematic cross-sectional front view of a magnetic turbine and associated electrical circuits built in accordance with an embodiment of the present invention.

FIG. 2 is a graphical view of three phase sine wave electrical signals driven into or produced by the apparatus of FIG. 1.

FIG. 3 is a schematic view of the magnetic turbine and associated electrical circuits of FIG. 1.

FIG. 4 is a graphical view of three phase quasi-sine wave electrical signals driven into or produced by the apparatus of FIG. 1.

FIGS. 5a-5f are partly schematic cross-sectional front views illustrating sequential magnetic states in the apparatus of FIG. 1.

FIGS. 6a-6f are partly schematic cross-sectional front views illustrating sequential magnetic transitions in and external to the apparatus of FIG. 1.

FIG. 7 is a partly schematic cross-sectional front view illustrating magnetic flux flow in and external to the apparatus of FIG. 1.

### DETAILED DESCRIPTION OF THE INVENTION

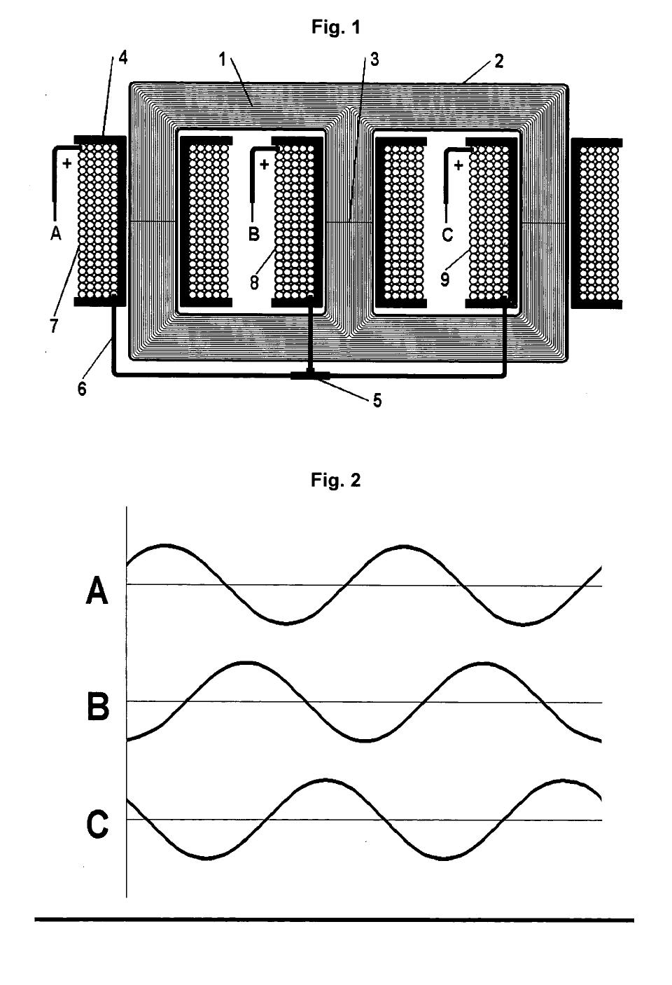

FIG. 1 is a partly schematic cross-sectional front view of an electromagnetic turbine, and associated magnetic core 1 with protective insulating coating 2 and electrical coils 7, 8, 9 built in accordance with an embodiment of the present invention. The flux core material 1 is configured to form three magnetic paths and two adjacent closed magnetic loops, the three coils 7, 8, 9 extending individually around portions of each magnetic path. The three magnetic paths contain butt joints 3 that allows assembly of cut core 1 after the coils 7, 8, 9 are wound on bobbins 4. An alternative embodiment with uncut core 1 requires more difficult winding of coils 7, 8, 9 on split bobbins 4 between the two adjacent closed magnetic loops. Positively phased ends of coils 7, 8, 9 indicated by ‘+’ signs have their external electrical connections indicated by letters ‘A’, ‘B’, ‘C’ respectively. Negatively phased ends of coils 7, 8, 9 are joined at electrical splice 5 with leads 6.

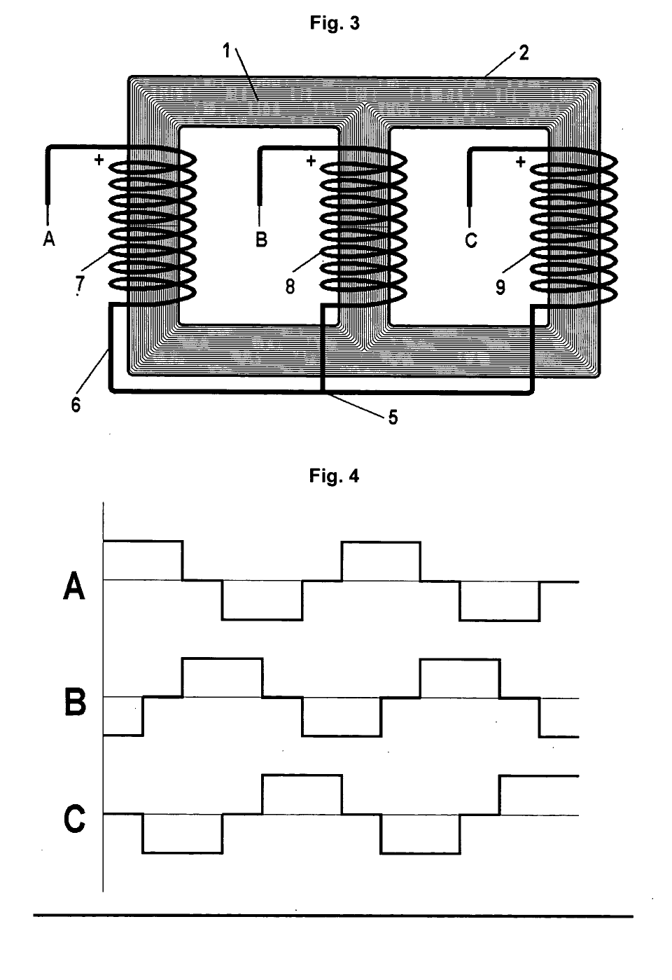

FIG. 2 is a graphical view of electrical signals driven into or produced by the apparatus of FIG. 1 represented by the schematic of FIG. 3. Letters ‘A’, ‘B’, ‘C’ of FIG. 2 represent electrical connections to coils 7, 8, 9 through letters ‘A’, ‘B’, ‘C’ of FIG. 1 and FIG. 3. The vertical hairline represents an instant in time by which the three electrical signals ‘A’, ‘B’, ‘C’ are synchronized, with time proceeding synchronously to the right. Three horizontal hairlines indicate zero for each electrical signal, with relative positive electrical potential proceeding upward and relative negative electrical potential proceeding downward. The timing of the signals is such that each signal leads or lags the other two signals in time by equal amounts. One skilled in the art will recognize FIG. 2 as a representation of a three-phase sine wave typical of a three-phase electromechanical generator or of an electronically switched three-phase inverter with pulse width modulation control.

FIG. 3 is a schematic representation of the electromagnetic turbine of FIG. 1, with associated magnetic core 1, protective insulating coating 2 and electrical coils 7, 8, 9. Positively phased ends of coils 7, 8, 9 indicated by ‘+’ signs have their external electrical connections indicated by letters ‘A’, ‘B’, ‘C’ respectively. Negatively phased ends of coils 7, 8, 9 are joined at electrical splice 5 with leads 6.

FIG. 4 is a graphical view of electrical signals driven into the apparatus of FIG. 1 represented by the schematic of FIG. 3. Letters ‘A’, ‘B’, ‘C’ of FIG. 4 represent electrical connections to coils 7, 8, 9 through letters ‘A’, ‘B’, ‘C’ of FIG. 1 and FIG. 3. The vertical hairline represents an instant in time by which the three electrical signals ‘A’, ‘B’, ‘C’ are synchronized, with time proceeding synchronously to the right. Three horizontal hairlines indicate zero for each electrical signal, with relative positive electrical potential proceeding upward and relative negative electrical potential proceeding downward. The timing of the signals is such that each signal leads or lags the other two signals in time by equal amounts. One skilled in the art will recognize FIG. 2 as a representation of a three-phase quasi-sine wave typical of an electronically switched three-phase inverter without pulse width modulation control.

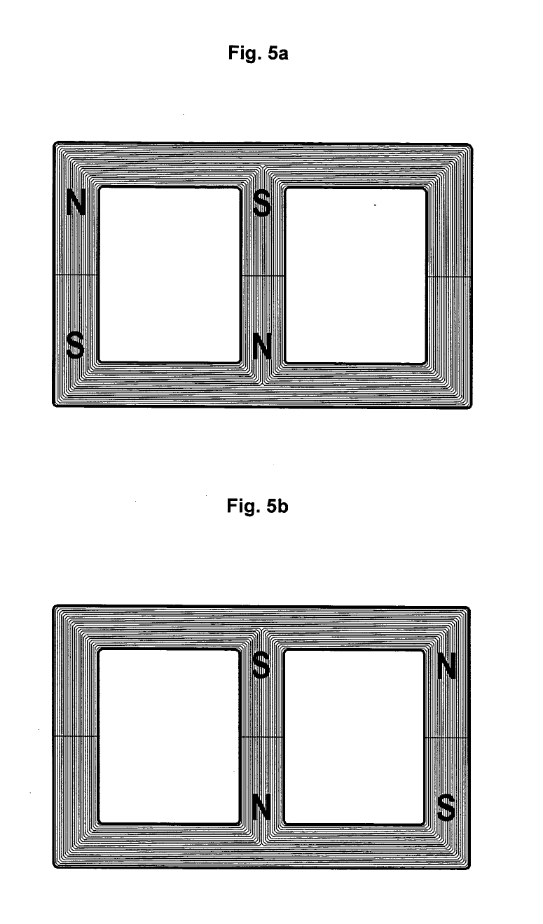

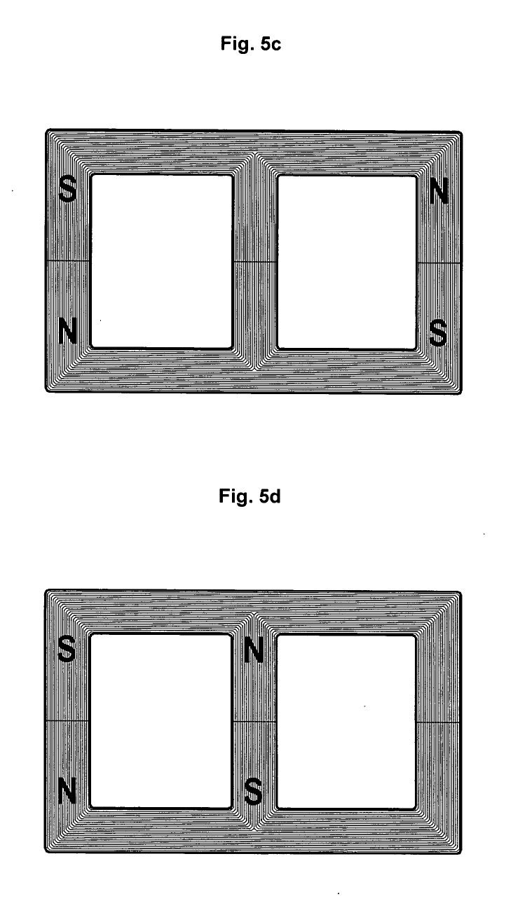

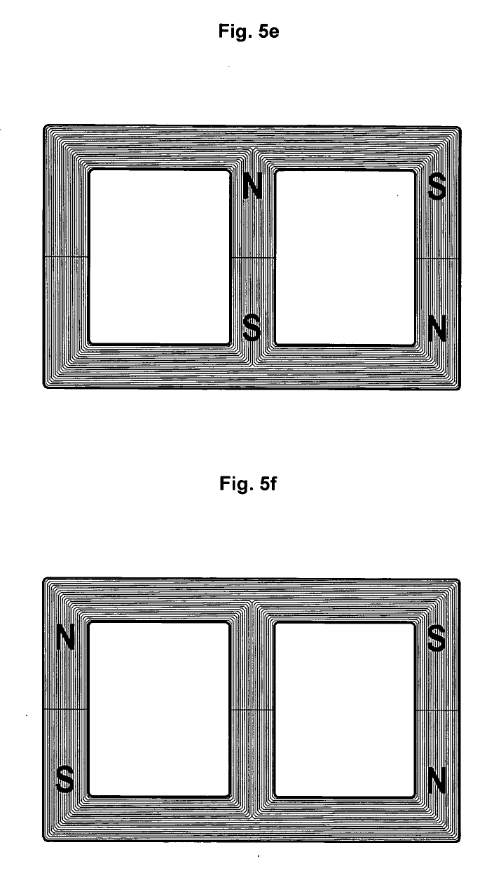

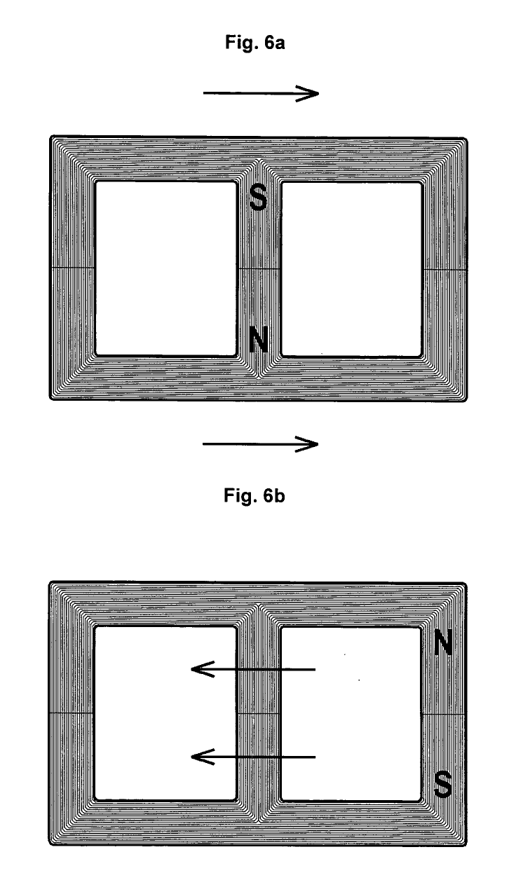

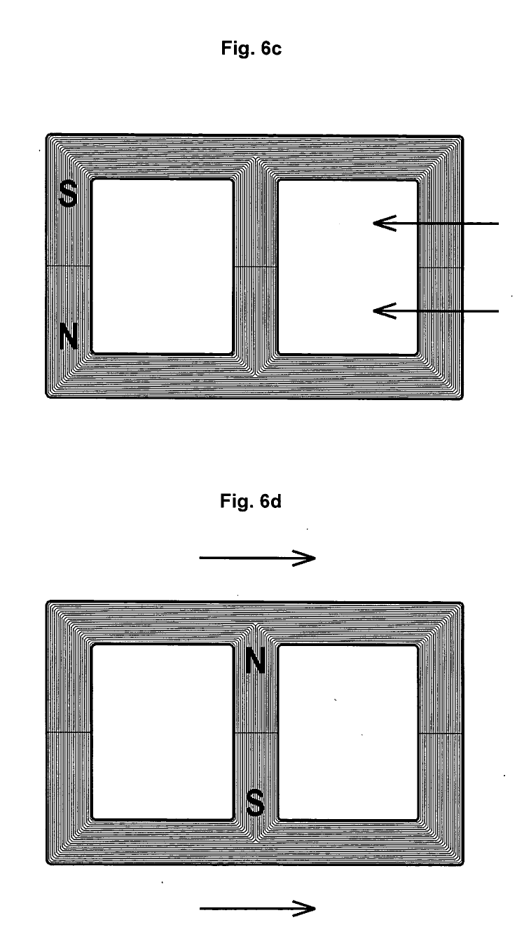

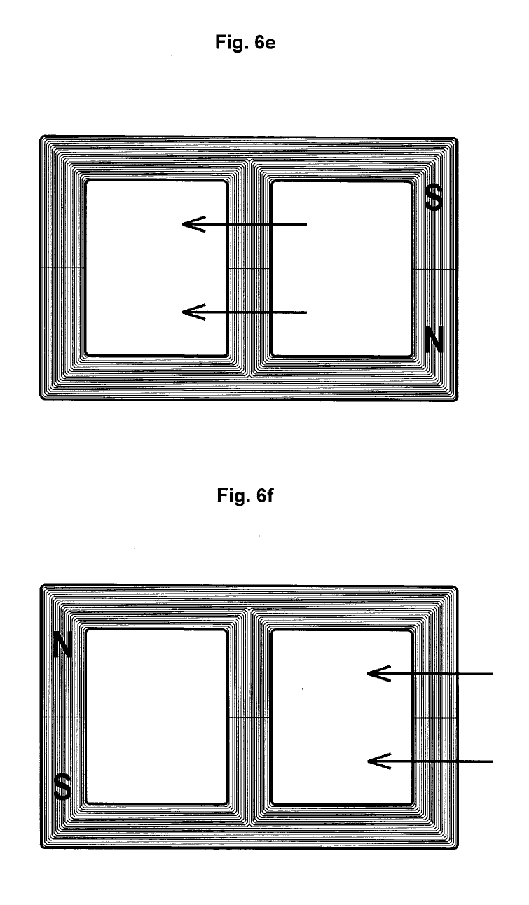

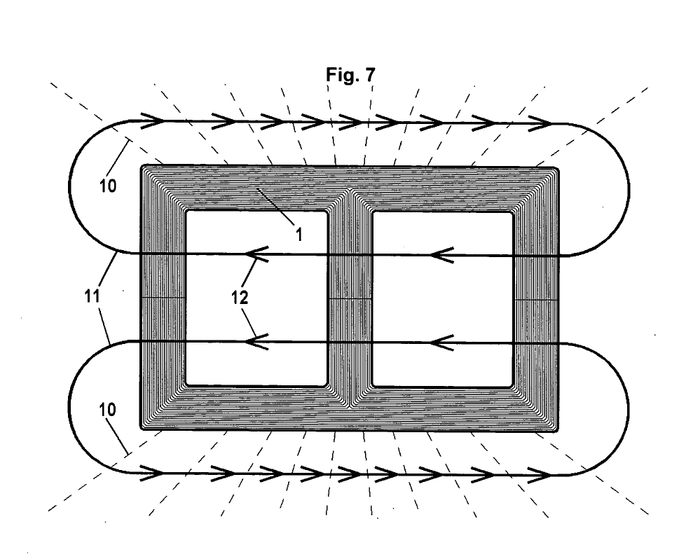

FIGS. 5a-5f are partial schematic representations of sequential magnetic states and FIGS. 6a-6f are partial schematic representations of sequential magnetic transitions in the apparatus of FIG. 1 with magnetic pole orientation indicated by the letters ‘N’ and ‘S’ for respective north and south magnetic poles. For clarity, the magnetic orientation is arbitrarily defined as proceeding vertically from top to bottom where a north to south orientation is represented as ‘N-S’.

FIG. 5a arbitrarily illustrates the first state with left path oriented ‘N-S’, center path ‘S-N’, and right path neutral. FIG. 6a illustrates the first transition with electrical inputs arranged to neutralize magnetic flux in the left path, hold flux constant in the center path, and attract flux into the right path. The flux is forced to extend outward from the left path, and sweep external to the core to the right side where it collapses into the right path. After the first transition, the second state of FIG. 5b is attained with left path neutral, center path ‘S-N’, and right path ‘N-S’. FIG. 6b illustrates the second transition with electrical inputs arranged to neutralize flux in center path, hold flux constant in right path, and attract flux into left path. The flux is forced to extend left from the center path, forcing the flux inside the left core loop to the left side, where it collapses into the left path. After the second transition, the third state of FIG. 5c is attained with center path neutral, left path ‘S-N’, and right path ‘N-S’. FIG. 6c illustrates the third transition with electrical inputs arranged to neutralize flux in right path, hold flux constant in left path, and attract flux into center path. The flux is forced to extend left from the right path, forcing the flux inside the right core loop to the center, where it collapses into the center path. After the third transition, the fourth state of FIG. 5d is attained with right path neutral, left path ‘S-N’, and center path ‘N-S’. FIGS. 5d-5f and 6d-6f illustrate states and transitions 4, 5, 6 similar to states and transitions 1, 2, 3, except with opposite polarities. After the sixth transition, the state reverts to the original first state of FIG. 5a where the sequence continues. It will be obvious to someone skilled in the art that reversing the sequence, or swapping two signal phases will reverse the flow of magnetic flux.

FIG. 7 is a partial schematic representation of net magnetic flux flow in and external to the apparatus of FIG. 1. When the apparatus is operating in proper sequence, magnetic flux 10 flows continuously through the inside of core 1 and then sweeps external to the core 1 according to a path of similar flux energy illustrated by ellipsoid 11. The flux external to the core is leveraged in reference to a magnetic pivot point inside the core causing the impulse of magnetic flux sweeping at a distance from the core to be faster than the impulse of the flux within the core. The leveraging ratio is proportional to the distance between the magnetic pivot point and the material that the sweeping flux is interacting with, and the distance between the pivot point and the flux impulse in the core. The external flux impulse speed is a product of the flux impulse speed in the core and the leveraging ratio. As magnetic flux has no mass, it is shown that as the frequency of the electrical signal increases from kilohertz and megahertz to gigahertz, the impulse speed within the core will increase proportionately, limited by properties of the core, coils, electronic switches, and available electrical power. It is also shown that the sweeping flux extends out to infinity with the energy density of the flux diminished proportional to the distance from the core. Despite the flux energy density being diminished with distance from the core, the possibility exists for the sweeping flux impulse to achieve exceedingly high speeds, well beyond any prior art propulsion mechanism. Indeed, as the flux impulse speed within the core approaches the speed of light, also known as the impulse speed of transverse electromagnetic compression waves, at a distance the external flux impulse speed will be proportionately faster by the previously illustrated leveraging ratio. Therefore, as the external distance increases, and the flux impulse within the core approaches the speed of light, the external flux impulse speed goes well beyond the speed of light.

In accordance with a preferred embodiment of the present invention, the coils 7, 8, 9 are driven by a three-phase electrical signal with variable frequency, voltage and current. The current must be limited such that the core material 1 never becomes saturated. Driving the core material 1 to saturation means that subsequent increases in current can occur without effecting corresponding changes in magnetic flux, and therefore wasting power. The electromagnetic turbine works by changing the flux pattern; it does not necessarily need to be completely switched from one polarity to another. Also, the voltage, current, and frequency must not exceed the electrical insulating, power handling, or heat dissipating capabilities of the core and coils.

In accordance with the present invention, material used for magnetic cores preferably has a high saturation flux density and magnetic permeability with low core loss at high frequencies. The core material is usually in a laminated form using grain-oriented, amorphous, or nanocrystalline magnetically permeable material. Powdered, ceramic, air, or vacuum cores can be used in special applications. The preferred embodiment illustrates a tape-wound cut core with three equally sized paths and two closed adjacent loops, typical of a three-phase ‘core transformer’, as compared to a three-phase ‘shell transformer’ with five paths and four loops, or a three-phase ‘symmetrical transformer’ with four paths and three loops.

The coil winding conductor material is typically enameled copper, although other materials such as superconductors can be used in special applications. The electrical voltage and current is readily adjusted by varying the number of turns in the coils and gauge of the conductors in accordance with well known electrical engineering principles. Thus, an electromagnetic turbine operating in accordance with the present invention must be considered as an induction motor where electricity is converted into relative motion in an externally conductive material, or as an induction generator where relative motion in an externally conductive material is converted into electricity.

While the invention has been described in a preferred embodiment, it must be understood that this description has been given as an example, and that numerous changes in the details of construction and arrangement of parts may be made without departing from the spirit and scope of the invention.

1. An electromagnetic turbine without moving parts, comprised of;
a magnetic core with three magnetic paths and magnetic connectors arranged between the three paths forming two adjacent closed magnetic loops;
three coils extending individually around portions of said three magnetic paths;
said three coils electrically pulsed to provide current pulses in said coils;
driving electrical current through each of said three coils in sequence results in a flow of magnetic flux external to said magnetic core;
said sequence is arranged to create a continuous one-way flow of magnetic flux through the inside of said core, then out one end where said magnetic flux extends outward from said core and sweeps external to said core to the opposite end of said core where said flux collapses into said core;
said sweeping magnetic flux induces electrical currents into electrically conductive material external to and not part of said turbine;
magnetic flux from said external currents interacts with said sweeping flux, resulting in a net force; where,
said force absorbs energy from relative deceleration of external material, converting said deceleration to electrical energy; or,
electrical energy provides relative acceleration of external material, converting said energy to said acceleration.

2. The electromagnetic turbine of claim 1, wherein said magnetic core is comprised of a magnetically permeable material with a high saturation flux density and low core loss at high frequencies including;
a core material in laminated form using amorphous, nanocrystalline, grain-oriented, non-oriented, or other magnetically permeable alloys; or
a core material comprised of bound powdered, ceramic, or other magnetically permeable compounds; or
a core material comprised of air or other electrically insulating substance; or
a core material comprised of a vacuum.

3. The electromagnetic turbine of claim 1, wherein said coils are comprised of an electrically conductive material with a high current handling capability, low resistance, and electrical insulation between adjacent windings and said core, including;
copper or other metal or alloy with enamel or other electrically insulating coating or sheath; or
a non-metallic electrical conductor surrounded by electrically insulating material; or
a superconductor surrounded by electrically insulating material.

4. The electromagnetic turbine of claim 1, wherein said electrical signals are provided by a three-phase electrical source with controllable frequency, voltage and current allowing generation and regeneration of electrical power, including;
an electronically switched three-phase quasi-sine wave inverter without pulse width modulation control; or
an electronically switched three-phase sine wave inverter with pulse width modulation control; or
an electromechanical three-phase sine wave generator; or
an alternate three-phase sine wave or quasi-sine wave generator.
